(19) United States
(12) Patent Application Publication
(10) Pub. No.: US 2014/0239763 A1
(43) Pub. Date: Aug. 28, 2014

(54) DUAL MAGNETIC PHASE STATOR LAMINATIONS FOR STATOR PERMANENT MAGNET ELECTRIC MACHINES

(71) Applicant: GENERAL ELECTRIC COMPANY, Schenectady, NY (US)

(72) Inventors: Tsarafidy Raminosoa, Niskayuna, NY (US); Ayman Mohamed Fawzi EL-Refaie, Niskayuna, NY (US); James Pellegrino Alexander, Ballston Lake, NY (US)

(73) Assignee: GENERAL ELECTRIC COMPANY, Schenectady, NY (US)

(21) Appl. No.: 13/780,773

(22) Filed: Feb. 28, 2013

(51) Int. Cl. H02K 1/17; H02K 15/03

(52) U.S. Cl. CPC H02K 1/17; H02K 15/03
USPC 310/154.44; 29/596

(57) ABSTRACT

A dual magnetic phase stator lamination for use in stator permanent magnet electric machines is disclosed. The permanent magnet electrical machine includes a rotor mounted for rotation about a central axis and a stator positioned about the rotor and comprising a plurality of stator laminations, wherein each of the stator laminations is composed of a dual magnetic phase material and includes a first stator lamination portion comprising a magnetic material and a second stator lamination portion comprising a non-magnetic material, the second stator lamination portion comprising an area positioned adjacent to each of a plurality of permanent magnets embedded in the stator lamination. The second stator lamination portion comprises a heat treated portion of the stator lamination, with the heat treating of the second stator lamination portion rendering the dual magnetic phase material of the stator lamination non-magnetic at the locations of the second stator lamination portion.

### GOVERNMENT LICENSE RIGHTS

This invention was made with Government support under contract number DE-EE0005573 awarded by the United States Department of Energy. The Government has certain rights in the invention.

### BACKGROUND OF THE INVENTION

The invention relates generally to electrical machines and, more particularly, to a dual magnetic phase stator lamination for use in permanent magnet electric machines having the magnets in the stator.

The usage of electrical machines in various industries has continued to become more prevalent in numerous industrial, commercial, and transportation industries over time. In an attempt to realize high performance in electric machines, the choice of using permanent magnet (PM) materials is getting more and more popular for many applications. In such machines, the PMs can either replace electromagnets in traditional designs, or novel topologies can be developed to make the best use of the properties and characteristics of PMs.

One PM electrical machine topology that has been developed is referred to as “stator permanent magnet machines,” which are electrical machines that are designed such that the PMs in the machine are positioned on the stator. Stator permanent magnet machines can thus refer to, but are not limited to, permanent magnet flux switching machines, permanent magnet flux reversal machines, and doubly-salient permanent magnet machines.

Stator permanent magnet machines are typically designed such that the PMs in the machine are embedded in the stator. To embed the PMs, a plurality of discrete stator laminations comprised of a soft, magnetic material are manufactured so as to have open slots formed therein, with the open slots being formed to accommodate placement of the permanent magnets therein. In each of the stator laminations, “bridges” are included on one or both sides of the permanent magnets to provide mechanical strength to the lamination. Typically, these bridges are formed of the same soft, magnetic material as the rest of the lamination, so as to enable formation of the lamination via a single cutting operation and from a single piece of magnetic material, rather than a segmented or multi-part lamination.

While the bridges found in typical stator laminations of a stator permanent magnet machine provide the mechanical robustness necessary for the laminations to be easily formed (such as in a single cutting operation), the bridges also can have a negative impact on the machine's power capability. That is, as the bridges are formed of the same soft, magnetic material as the rest of the stator lamination, the bridges form a leakage path for the permanent magnet flux, thereby reducing the machine's power capability. Furthermore, as the magnetic bridges of the stator laminations need to be thick in order to provide sufficient mechanical strength to the lamination, this thickness of the bridges provides a larger leakage path for the permanent magnet flux, so as to further reduce the machine's power capability.

Therefore, it would be desirable to provide stator laminations for a stator permanent magnet machine that can be formed via a single cutting operation, while minimizing the permanent magnet flux leakage typically associated with laminations formed from a single material so as to increase the machine's power capability.

### BRIEF DESCRIPTION OF THE INVENTION

The invention is directed to stator laminations for a stator permanent magnet machine. The stator laminations are formed of a dual magnetic phase material and are heat treated such that portions of each stator lamination are rendered non-magnetic, so as to block paths of permanent magnet flux leakage in the stator lamination.

In accordance with one aspect of the invention, a permanent magnet electrical machine includes a rotor mounted for rotation about a central axis and a stator positioned about the rotor and comprising a plurality of stator laminations, wherein each of the stator laminations is composed of a dual magnetic phase material and includes a first stator lamination portion comprising a magnetic material and a second stator lamination portion comprising a non-magnetic material, the second stator lamination portion comprising an area positioned adjacent to each of a plurality of permanent magnets embedded in the stator lamination. The second stator lamination portion comprises a heat treated portion of the stator lamination, with the heat treating of the second stator lamination portion rendering the dual magnetic phase material of the stator lamination non-magnetic at the locations of the second stator lamination portion.

In accordance with another aspect of the invention, a method for manufacturing a permanent magnet electrical machine includes the steps of providing a rotor mounted for rotation about a central axis and forming each of a plurality of stator laminations for use in forming a stator, wherein forming each of the plurality of stator laminations further includes the step of providing a non-segmented stator lamination formed of a dual magnetic phase material that is magnetic in a first state and non-magnetic in a second state, with the non-segmented stator lamination being provided in the magnetic first state. Forming each of the plurality of stator laminations further includes the steps of embedding a plurality of permanent magnets in the stator lamination and heat treating the stator lamination at a plurality of pre-determined locations adjacent to the plurality of permanent magnets so as to cause the pre-determined locations of the stator lamination to transition to the non-magnetic second state. The method further includes the step of joining the stator laminations to form a stator, with the stator being positioned about the rotor so as to enable rotation of the rotor within the stator.

In accordance with yet another aspect of the invention, a stator lamination for a permanent magnet electrical machine includes an outer casing, a plurality of teeth extending radially inward from the outer casing, and a plurality of openings formed in one of the outer casing and the plurality of teeth, wherein a bridge structure is formed adjacent each opening to provide mechanical stability to the stator lamination. The stator lamination also includes a plurality of permanent magnets embedded in the stator lamination within the plurality of openings, such that the plurality of permanent magnets in one of the outer casing or the plurality of teeth. The stator lamination is formed of a dual magnetic phase material, with the bridge structures being heat treated so as to be in a non-magnetic state and a remainder of the stator lamination being in a magnetic state, such that the bridge structures block a leakage path of permanent magnet flux.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a schematic perspective view of an overall permanent magnet electrical machine in accordance with an embodiment of the invention.

FIG. 2 is a schematic perspective view of a stator of the electrical machine of FIG. 1.

FIG. 3 is a schematic diagram of a stator lamination configuration for the electrical machine of FIG. 1 according to an embodiment of the invention.

FIGS. 3A-3C are detailed views of varying embodiments of a non-magnetic bridge for use in the stator lamination of FIG. 3.

FIG. 4 is a schematic diagram of a stator lamination configuration for the electrical machine of FIG. 1 according to an embodiment of the invention.

FIGS. 4A-4C are detailed views of varying embodiments of a non-magnetic bridge for use in the stator lamination of FIG. 4.

FIG. 5 is a schematic diagram of a stator lamination configuration for the electrical machine of FIG. 1 according to an embodiment of the invention.

FIGS. 5A-5B are detailed views of varying embodiments of a non-magnetic bridge for use in the stator lamination of FIG. 5.

FIG. 6 is a schematic diagram of a stator lamination configuration for the electrical machine of FIG. 1 according to an embodiment of the invention.

FIGS. 6A-6C are detailed views of varying embodiments of a non-magnetic bridge for use in the stator lamination of FIG. 6.

FIG. 7 is a schematic diagram of a stator lamination configuration for the electrical machine of FIG. 1 according to an embodiment of the invention.

FIGS. 7A-7B are detailed views of varying embodiments of a non-magnetic bridge for use in the stator lamination of FIG. 7.

FIG. 8 is a schematic diagram of a stator lamination configuration for the electrical machine of FIG. 1 according to an embodiment of the invention.

FIGS. 8A-8C are detailed views of varying embodiments of a non-magnetic bridge for use in the stator lamination of FIG. 8.

FIG. 9 is a schematic diagram of a stator lamination configuration for the electrical machine of FIG. 1 according to an embodiment of the invention.

FIG. 9A is a detailed view of an embodiment of a non-magnetic bridge for use in the stator lamination of FIG. 9.

### DETAILED DESCRIPTION OF THE PREFERRED EMBODIMENT

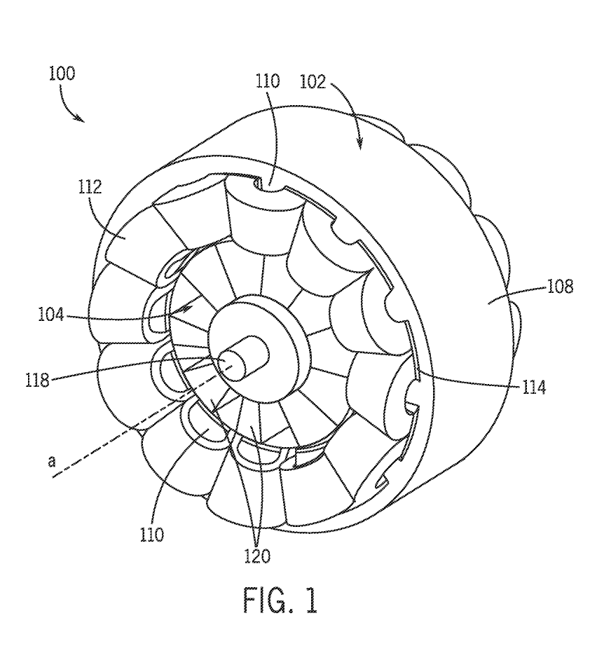

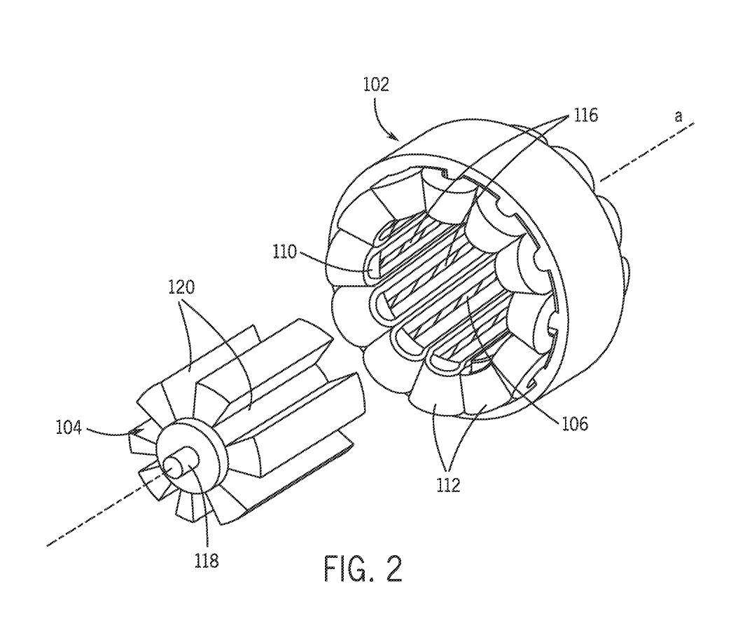

Referring to FIGS. 1 and 2, therein are shown views of a portion of a stator permanent magnet machine 100 (such as an electric motor or generator). The stator permanent magnet machine 100 can include a substantially concentrically disposed stator 102 and rotor 104. For example, the stator 102 can define a stator bore 106 within which the rotor 104 can be disposed. The stator bore 106 and the rotor 104 may be substantially cylindrical, and may be elongated so as to define an axis a. The rotor 104 can be coupled to a shaft 118 that is configured to rotate about the axis a.

The stator section may include an outer casing 108 (sometimes referred to as the “back iron” or “yoke”), and one or more teeth 110 each extending, say, radially inward from the outer casing. Conductive windings 112 can be wound around respective teeth 110. Insulation 114 can be included so as to provide electrical isolation between the outer casing 108/teeth 110 and the conductive windings 112. The stator 102 also includes one or more permanent magnets 116 that are embedded in the stator (i.e., either in the teeth 110 or in the casing 108), with the magnets being magnetized such that the magnetization polarities of the magnets alternate circumferentially around the stator 102.

During operation of the stator permanent magnet machine 100, the shaft 118 and rotor 104 rotate about the axis a. Depending on whether the stator permanent magnet machine 100 is a generator or a motor, electric current in the conductive windings 112, interacting with magnetic fields associated with the magnets 116, will either be induced by or cause rotation of the rotor 104. In the former case, work done on the shaft 118 can induce rotation of the shaft and rotor 104 and current flow in the windings 112, while in the latter, current injected into the windings can cause rotation of the rotor and shaft as the rotor attempts to bring the rotor teeth 120 positioned thereon to a position of minimum reluctance with respect to the stator teeth 110.

Regarding the stator 102 shown in FIGS. 1 and 2, the stator 102 is not formed as a single, solid machined piece, but instead is comprised of a plurality of stator laminations 26 that are stacked axially and pressed to form the stator. Each of the laminations is formed of a material that can be stamped or cut, for example, to form the metallic laminations. According to embodiments of the invention, the material used to form the laminations comprises a dual magnetic phase material that can be selectively treated to form magnetic portions and non-magnetic portions in the lamination. Specifically, the dual magnetic phase material can initially have magnetic properties, with a heat treating being applied to desired areas of the lamination to render those areas non-magnetic. According to an exemplary embodiment of the invention, one or both sides of a bridge formed on opposing sides of each permanent magnet is heat treated to render the one/both sides of the bridge non-magnetic. By rendering one or both sides of each bridge non-magnetic, any leakage path for the permanent magnet flux through the bridge is blocked.

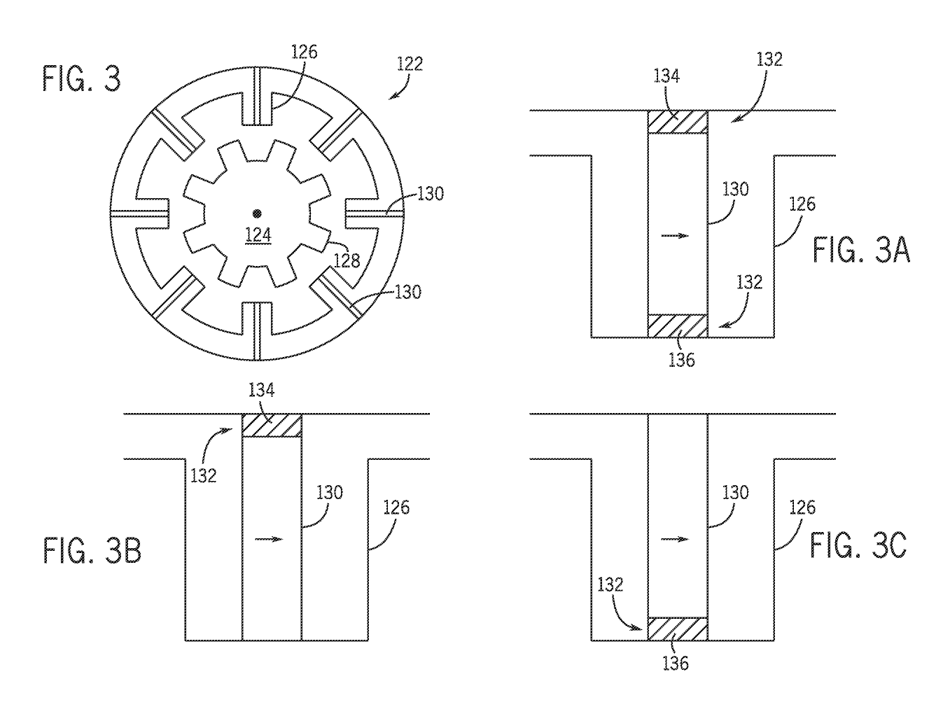

Referring now to FIGS. 3-9, stator laminations (such as could be used to form stator 102 in FIGS. 1 and 2) for use in a number of various stator permanent magnet machines are shown according to embodiments of the invention, where the permanent magnets and concentrated windings are located in the stator instead of the conventional rotor permanent magnet topology. The stator lamination in each of the various embodiments is formed from a dual magnetic phase material that is selectively treated to form non-magnetic portions in the stator lamination, such as one or both sides of a bridge formed about each permanent magnet embedded in the stator lamination.

Referring to FIG. 3, a schematic plan view of a stator lamination 122 for use in a permanent magnet flux-switching machine is shown according to an embodiment of the invention. The stator lamination 122 is shown positioned relative to a rotor 124 of the permanent magnet flux-switching machine, with the stator lamination 122 and the rotor 124 each having respective teeth 126, 128. A permanent magnet 130 is embedded on each tooth of the stator lamination 122. In the embodiment of FIG. 3, a permanent magnet 130 is positioned on each tooth 126 so as to be geometrically oriented in a direction parallel to the tooth (i.e., in a radial direction), with the permanent magnets 130 generating magnetization in a circumferential direction (i.e., perpendicular to the tooth). As shown in FIGS. 3A-3C, a bridge 132 is present on one or both of opposing sides of each permanent magnet 130 to provide mechanical stability to the stator lamination, with one or both edges of the bridge 132 being heat treated to render the one/both sides of the bridge non-magnetic. The bridge 132 is shown as being formed and heat treated to be non-magnetic on both sides 134, 136 of the permanent magnet (FIG. 3A), on an outer edge 134 of the permanent magnet (FIG. 3B), and on an inner edge 136 of the permanent magnet (FIG. 3C). In each of the embodiments of FIGS. 3A-3C, the non-magnetic portion(s) of the bridge 132 thus blocks any leakage path for the permanent magnet flux through the bridge.

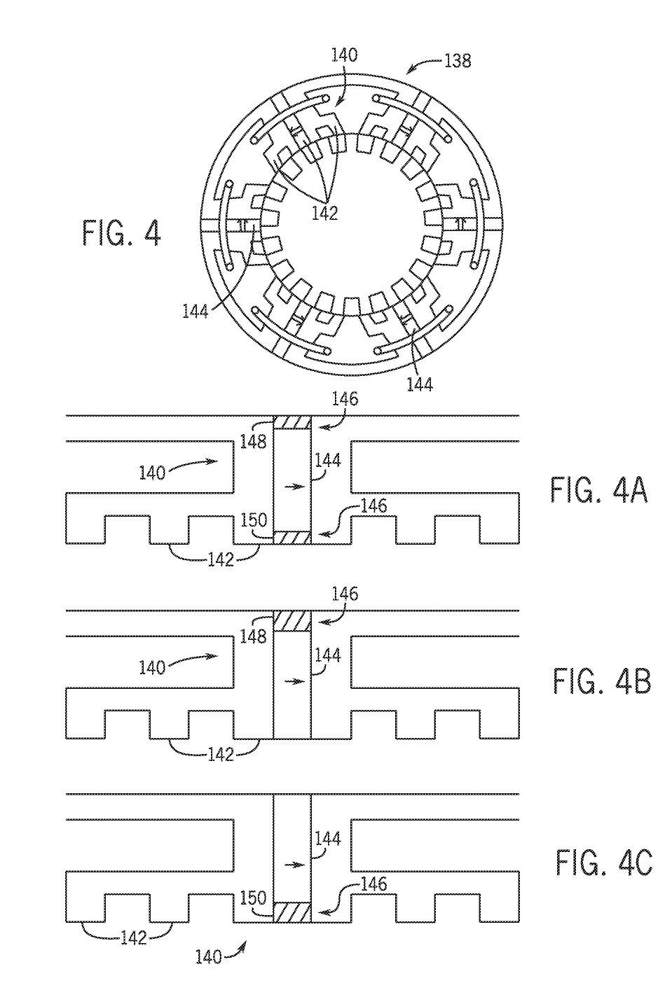

Referring now to FIG. 4, a schematic plan view of a stator lamination 138 for use in a different permanent magnet flux-switching machine is shown according to an embodiment of the invention. The stator lamination 138 is formed as a multi-tooth permanent magnet flux-switching machine lamination, with each of the teeth 140 of the stator having multiple sub-teeth 142 formed thereon. A permanent magnet 144 is embedded on each tooth 140 of the stator lamination 138. In the embodiment of FIG. 4, a permanent magnet 144 is positioned on each tooth 140 so as to be geometrically oriented in a direction parallel to the tooth (i.e., in a radial direction), with the permanent magnets 144 generating magnetization in a circumferential direction (i.e., perpendicular to the teeth). As shown in greater detail in FIGS. 4A-4C, a bridge 146 formed on one or both of opposing sides of each permanent magnet that is heat treated to render the one/both sides of the bridge 146 non-magnetic. The bridge 146 is shown as being heat treated to be non-magnetic on both sides 148, 150 of the permanent magnet (FIG. 4A), on an outer edge 148 of the permanent magnet (FIG. 4B), and on an inner edge 150 of the permanent magnet (FIG. 4C), so as to block any leakage path for the permanent magnet flux through the bridge 146.

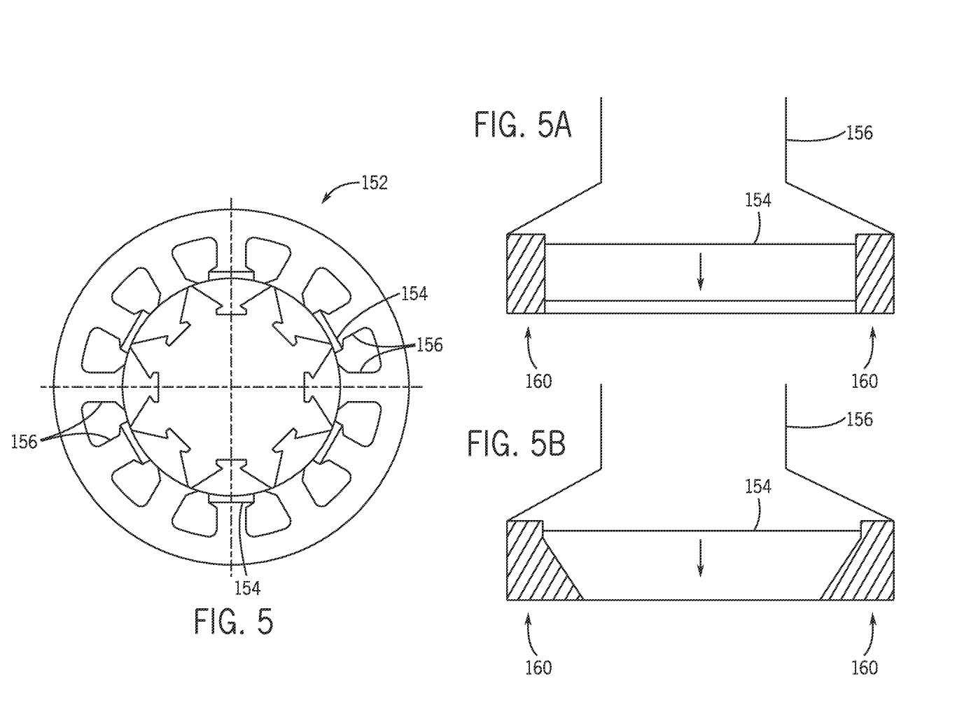

Referring now to FIG. 5, a schematic plan view of a stator lamination 152 for use in yet another permanent magnet flux-switching machine is shown according to an embodiment of the invention. As shown in FIG. 5, permanent magnets 154 are embedded on teeth 156 of the stator lamination 152 so as to be geometrically oriented in a direction perpendicular to the teeth and positioned crosswise on the inner edge 158 of the teeth, while generating magnetization in a direction parallel to the teeth. As shown in FIGS. 5A-5B, a bridge 160 is formed on both sides of each permanent magnet 154 that is heat treated to render the bridge 160 non-magnetic. Referring to FIGS. 5A-5B, the non-magnetic bridge 160 is shown as varying in shape dependent upon the shape of the permanent magnet 154, with the heat treating of the stator lamination 152 being closely controlled to form non-magnetic bridges 160 having a desired shape. As is shown in FIG. 5, the permanent magnets 154 are located only in every other tooth 156, such that heat treating of the bridges 160 adjacent the permanent magnets 154 does not impede the main flux path in the stator lamination 152.

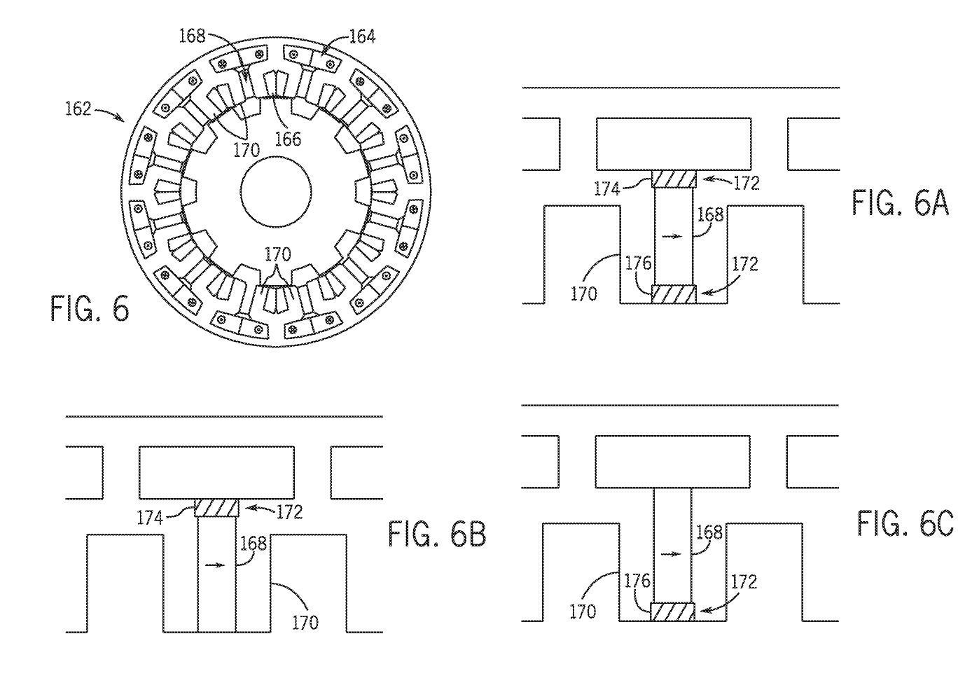

Another permanent magnet flux-switching machine stator lamination 162 is shown in FIG. 6 that employs a hybrid excitation method, by introducing a set of field windings 64 (along with the concentrated stator windings 166). In the embodiment of FIG. 6, a permanent magnet 168 is positioned on each tooth 170 so as to be geometrically oriented in a direction parallel to the tooth (i.e., in a radial direction), while generating magnetization in a circumferential direction (i.e., perpendicular to the tooth). Referring to FIGS. 6A-6C, a bridge 172 is formed on one or both sides of each permanent magnet 168 that is heat treated to render the one/both sides of the bridge non-magnetic. The bridge may be formed and heat treated to be non-magnetic on both sides 174, 176 of the permanent magnet (FIG. 6A), on an outer edge 174 of the permanent magnet (FIG. 6B), and on an inner edge 176 of the permanent magnet (FIG. 6C), so as to block any leakage path for the permanent magnet flux through the bridge 172.

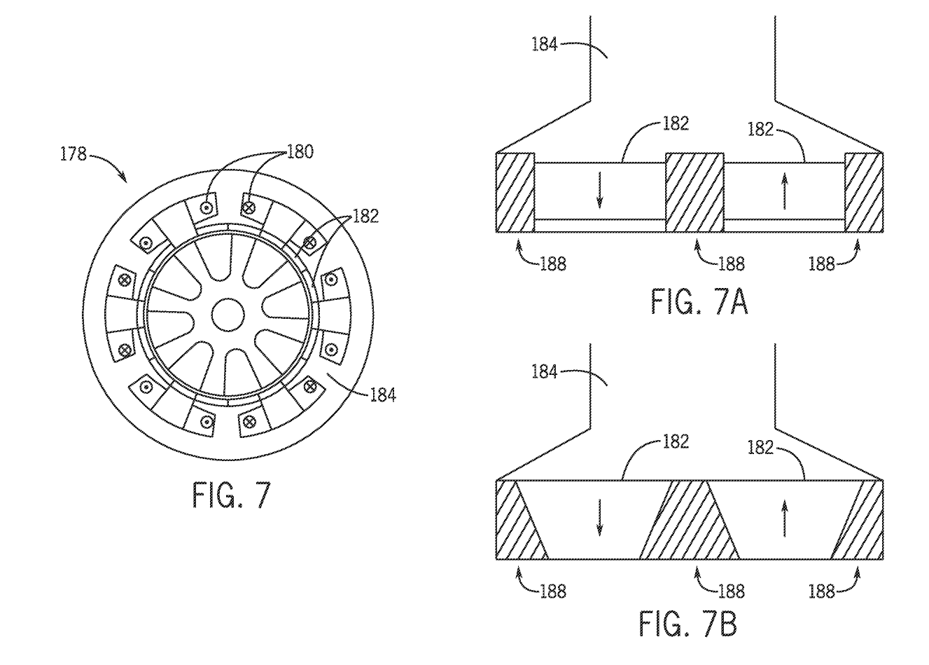

Referring now to FIG. 7, a stator lamination 178 for use in a permanent magnet flux reversal machine (FRM) is shown, with the permanent magnet FRM comprising a doubly-salient stator-permanent magnet machine. As shown in FIG. 7, a pair of permanent magnets 182 is embedded on each tooth 184 of the stator lamination 178 so as to be geometrically oriented in a direction perpendicular to the tooth and positioned crosswise on the inner edge 186 of the tooth 184, while generating magnetization in a direction parallel to the tooth. On each tooth 184, the pair of permanent magnets 182 are of opposite polarity—i.e., one north pole, one south pole. As shown in FIGS. 7A-7B, a bridge 188 is formed about the permanent magnets 182, with the bridge 188 being heat treated to render each of the three sections of the bridge (outside the magnets and between the magnets) non-magnetic. The non-magnetic bridge sections are shown in FIGS. 7A-7B as varying in shape dependent upon the shape of the permanent magnets 182, with the heat treating of the stator lamination 178 being closely controlled to form the non-magnetic sections of the bridge 188 with a desired shape.

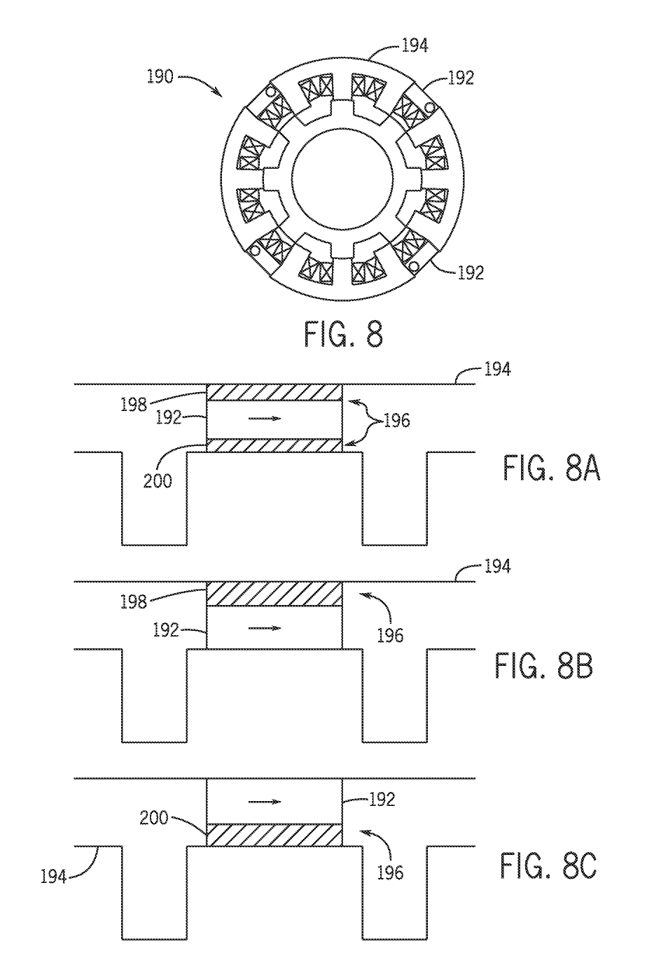

Referring now to FIG. 8, a stator lamination 190 for use in a doubly salient permanent magnet machine is shown, with the lamination having salient poles with respective windings thereon. In the stator lamination 190, the permanent magnets 192 are embedded in the outer casing/yoke 194 of the lamination and are spaced about a circumference of the casing. As shown in FIGS. 8A-8C, a bridge 196 is formed on one or both of opposing sides of each permanent magnet 192 (i.e., radially inward/outward sides of the magnets) and is heat treated to render the one/both sides of the bridge 196 non-magnetic. The bridge can be heat treated to be non-magnetic on both sides 198, 200 of the permanent magnet (FIG. 8A), on an outer edge 198 of the permanent magnet (FIG. 8B), and on an inner edge 200 of the permanent magnet (FIG. 8C), so as to block any leakage path for the permanent magnet flux through the bridge 196.

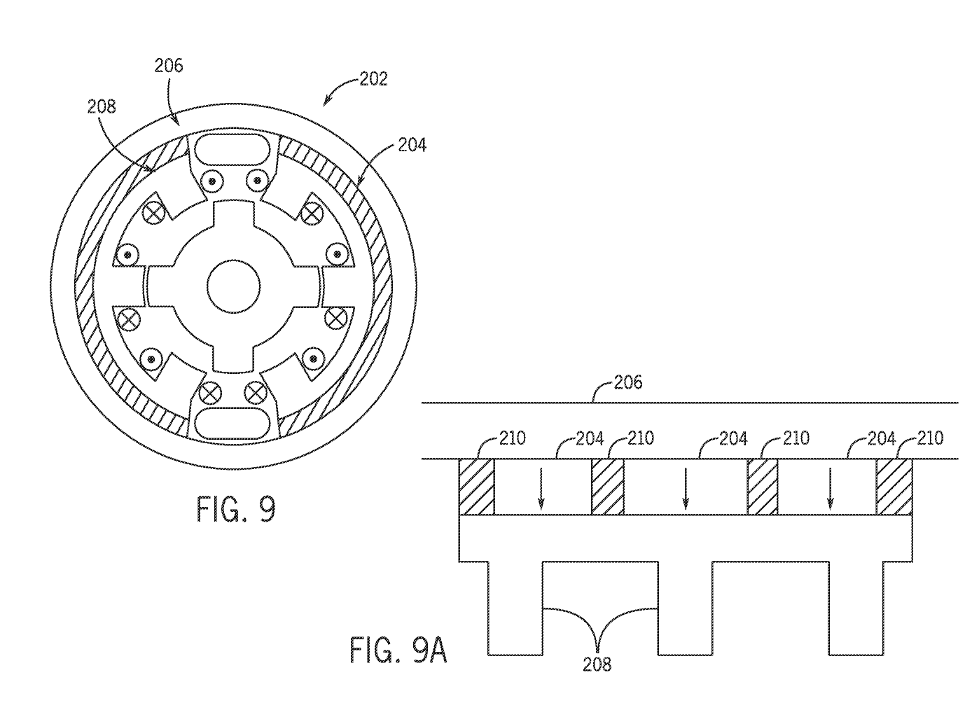

Another stator lamination 202 for use in a doubly salient permanent magnet or hybrid excited machine is shown in FIG. 9. In the stator lamination 202, the permanent magnets 204 are embedded between the outer casing/yoke 206 of the lamination 202 and the teeth 208. As shown in FIG. 9A, bridges 210 between pairs of permanent magnets 204 are heat treated to form non-magnetic areas about the permanent magnets, so as to block any leakage path for the permanent magnet flux.

Beneficially, embodiments of the invention thus provide a stator permanent magnet machine having stator laminations formed of a dual magnetic phase material. The dual magnetic phase material of the stator laminations can be heat treated to make portions of the stator lamination non-magnetic. Specifically, bridges on the stator lamination positioned adjacent the permanent magnets, on either one side or both sides of each permanent magnet, can be made non-magnetic. By making the bridges non-magnetic, any leakage path through the bridges for the permanent magnet flux is blocked, so as to increase the power capability of the machine.

In using dual magnetic phase material for the stator lamination, the non-magnetic bridges can be made thick as needed for robustness. Additionally, when using dual magnetic phase material for the stator lamination, the lamination can be cut as one whole lamination (i.e., integral) without segmentation such that the lamination has a uniform coefficient of thermal expansion, thereby easing a shrink fitting of a motor casing or a cooling jacket about the stator and reducing the cost of the stator assembly for certain type of stator PM machines, like flux switching machines, since there is no need to assemble several separate lamination segments. While such integral/singularly formed laminations have been previously available, they have not included non-magnetic portions that function to block a leakage path of the permanent magnet—thereby limiting the power capability of prior art machines.

Therefore, according to one embodiment of the invention, a permanent magnet electrical machine includes a rotor mounted for rotation about a central axis and a stator positioned about the rotor and comprising a plurality of stator laminations, wherein each of the stator laminations is composed of a dual magnetic phase material and includes a first stator lamination portion comprising a magnetic material and a second stator lamination portion comprising a non-magnetic material, the second stator lamination portion comprising an area positioned adjacent to each of a plurality of permanent magnets embedded in the stator lamination. The second stator lamination portion comprises a heat treated portion of the stator lamination, with the heat treating of the second stator lamination portion rendering the dual magnetic phase material of the stator lamination non-magnetic at the locations of the second stator lamination portion.

According to another embodiment of the invention, a method for manufacturing a permanent magnet electrical machine includes the steps of providing a rotor mounted for rotation about a central axis and forming each of a plurality of stator laminations for use in forming a stator, wherein forming each of the plurality of stator laminations further includes the step of providing a non-segmented stator lamination formed of a dual magnetic phase material that is magnetic in a first state and non-magnetic in a second state, with the non-segmented stator lamination being provided in the magnetic first state. Forming each of the plurality of stator laminations further includes the steps of embedding a plurality of permanent magnets in the stator lamination and heat treating the stator lamination at a plurality of pre-determined locations adjacent to the plurality of permanent magnets so as to cause the pre-determined locations of the stator lamination to transition to the non-magnetic second state. The method further includes the step of joining the stator laminations to form a stator, with the stator being positioned about the rotor so as to enable rotation of the rotor within the stator.

According to yet another embodiment of the invention, a stator lamination for a permanent magnet electrical machine includes an outer casing, a plurality of teeth extending radially inward from the outer casing, and a plurality of openings formed in one of the outer casing and the plurality of teeth, wherein a bridge structure is formed adjacent each opening to provide mechanical stability to the stator lamination. The stator lamination also includes a plurality of permanent magnets embedded in the stator lamination within the plurality of openings, such that the plurality of permanent magnets in one of the outer casing or the plurality of teeth. The stator lamination is formed of a dual magnetic phase material, with the bridge structures being heat treated so as to be in a non-magnetic state and a remainder of the stator lamination being in a magnetic state, such that the bridge structures block a leakage path of permanent magnet flux.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A permanent magnet electrical machine comprising:
a rotor mounted for rotation about a central axis; and
a stator positioned about the rotor and comprising a plurality of stator laminations, wherein each of the stator laminations is composed of a dual magnetic phase material and includes:
a first stator lamination portion comprising a magnetic material; and
a second stator lamination portion comprising a non-magnetic material, the second stator lamination portion comprising an area positioned adjacent to each of a plurality of permanent magnets embedded in the stator lamination;
wherein the second stator lamination portion comprises a heat treated portion of the stator lamination, with the heat treating of the second stator lamination portion rendering the dual magnetic phase material of the stator lamination non-magnetic at the locations of the second stator lamination portion.

2. The permanent magnet electrical machine of claim 1 further comprising a bridge positioned adjacent each of the plurality of permanent magnets, such that each bridge is formed on one or both sides of a respective permanent magnet.

3. The permanent magnet electrical machine of claim 2 wherein the second lamination portion comprises the bridges positioned adjacent the plurality of permanent magnets, with each bridge being non-magnetic on one or both sides of its respective permanent magnet.

4. The permanent magnet electrical machine of claim 3 wherein the plurality of permanent magnets are embedded in openings formed in teeth of the stator lamination and oriented generally parallel to a direction of the tooth, with each bridge being non-magnetic on both sides of a respective permanent magnet, on an outer edge of a respective permanent magnet, or on an inner edge of a respective permanent magnet.

5. The permanent magnet electrical machine of claim 3 wherein the plurality of permanent magnets are embedded in openings formed in teeth of the stator lamination so as to be oriented generally perpendicular to a direction of the teeth and along a face of the teeth, with each bridge being non-magnetic on both sides of a respective permanent magnet.

6. The permanent magnet electrical machine of claim 3 wherein the plurality of permanent magnets are embedded in openings formed in an outer casing of the stator lamination, with each bridge being non-magnetic on both sides of a respective permanent magnet, on an outer edge of a respective permanent magnet, or on an inner edge of a respective permanent magnet.

7. The permanent magnet electrical machine of claim 1 wherein the non-magnetic second stator lamination portion blocks a leakage path of permanent magnet flux.

8. The permanent magnet electrical machine of claim 1 wherein each of the plurality of stator laminations comprises an integral, non-segmented stator lamination formed as a single piece from the dual magnetic phase material.

9. The permanent magnet electrical machine of claim 8 wherein the integral, non-segmented stator lamination has a uniform coefficient of thermal expansion.

10. The permanent magnet electrical machine of claim 1 wherein the machine comprises one of a permanent magnet flux switching machine, a permanent magnet flux reversal machine, and a doubly salient permanent magnet machine.

11. A method for manufacturing a permanent magnet electrical machine, the method comprising:
providing a rotor mounted for rotation about a central axis;
forming each of a plurality of stator laminations for use in forming a stator, wherein forming each of the plurality of stator laminations comprises:
providing a non-segmented stator lamination formed of a dual magnetic phase material, the dual magnetic phase material being magnetic in a first state and non-magnetic in a second state, with the non-segmented stator lamination being provided in the magnetic first state;
embedding a plurality of permanent magnets in the stator lamination; and
heat treating the stator lamination at a plurality of pre-determined locations adjacent to the plurality of permanent magnets so as to cause the pre-determined locations of the stator lamination to transition to the non-magnetic second state; and
joining the stator laminations to form a stator, with the stator being positioned about the rotor so as to enable rotation of the rotor within the stator.

12. The method of claim 11 wherein each of the plurality of stator laminations comprises a plurality of bridges positioned adjacent the plurality of permanent magnets, such that a bridge is formed on one or both sides of each respective permanent magnet.

13. The method of claim 11 wherein heat treating the stator lamination at the plurality of pre-determined locations comprises heat treating the plurality of bridges.

14. The method of claim 11 wherein embedding the plurality of permanent magnets comprises embedding the plurality of permanent magnets in teeth of the stator lamination so as to be oriented generally parallel to a direction of the teeth; and
wherein heat treating the plurality of bridges comprises heat treating each bridge on both sides of a respective permanent magnet, heat treating each bridge on an outer edge of a respective permanent magnet, or heat treating each bridge on an inner edge of a respective permanent magnet.

15. The method of claim 11 wherein embedding the plurality of permanent magnets comprises embedding the plurality of permanent magnets in teeth of the stator lamination so as to be oriented generally perpendicular to a direction of the teeth and along a face of the teeth; and
wherein heat treating the plurality of bridges comprises heat treating each bridge on both sides of a respective permanent magnet.

16. The method of claim 11 wherein embedding the plurality of permanent magnets comprises embedding the plurality of permanent magnets in an outer casing of the stator lamination; and
wherein heat treating the plurality of bridges comprises heat treating each bridge on both sides of a respective permanent magnet, on an outer edge of a respective permanent magnet, or on an inner edge of a respective permanent magnet.

17. The method of claim 11 wherein heat treating the stator lamination at the plurality of pre-determined locations adjacent to the plurality of permanent magnets blocks a leakage path of permanent magnet flux.

18. A stator lamination for a permanent magnet electrical machine, the stator lamination comprising:
an outer casing;
a plurality of teeth extending radially inward from the outer casing;
a plurality of openings formed in one of the outer casing and the plurality of teeth, wherein a bridge structure is formed adjacent each opening to provide mechanical stability to the stator lamination; and
a plurality of permanent magnets embedded in the stator lamination within the plurality of openings, such that the plurality of permanent magnets in one of the outer casing or the plurality of teeth;
wherein the stator lamination is formed of a dual magnetic phase material, with the bridge structures being heat treated so as to be in a non-magnetic state and a remainder of the stator lamination being in a magnetic state, such that the bridge structures block a leakage path of permanent magnet flux.

19. The stator lamination of claim 18 wherein the plurality of permanent magnets are embedded in openings formed in the plurality of teeth, with each of the bridge structures being non-magnetic on both sides of a respective permanent magnet, on an outer edge of a respective permanent magnet, or on an inner edge of a respective permanent magnet.

20. The stator lamination of claim 18 wherein the plurality of permanent magnets are embedded in openings formed in the outer casing, with each of the bridge structures being non-magnetic on both sides of a respective permanent magnet, on an outer edge of a respective permanent magnet, or on an inner edge of a respective permanent magnet.

21. The stator lamination of claim 18 the stator lamination is formed as an integral, non-segmented stator lamination formed as a single piece from the dual magnetic phase material.
